(19) United States
(12) Patent Application Publication
(10) Pub. No.: US 2026/0074427 A1
(43) Pub. Date: Mar. 12, 2026

(54) DIELECTRIC TUNING FOR LDS ANTENNA

(71) Applicant: KYOCERA AVX Components (San Diego), Inc., San Diego, CA (US)

(72) Inventor: Olivier Pajona, Biot (FR)

(21) Appl. No.: 19/323,448

(22) Filed: Sep. 9, 2025

Related U.S. Application Data
(60) Provisional application No. 63/692,468, filed on Sep. 9, 2024.

(51) Int. Cl. H01Q 9/04

(52) U.S. Cl. CPC H01Q 9/0442

(57) ABSTRACT

A laser direct structuring (LDS) antenna is provided. The LDS antenna includes a carrier having a dielectric constant. The LDS antenna further includes an LDS-defined antenna element on the carrier. The carrier includes a dielectric tuning resin in at least a portion of the carrier.

### PRIORITY CLAIM

The present application claims the benefit of priority of U.S. Provisional Application Ser. No. 63/692,481, filed on Sep. 9, 2024, which is incorporated herein by reference.

### FIELD

The present disclosure related generally to a laser direct structuring (LDS) antenna, and more particularly to dielectric tuning for an LDS antenna.

### BACKGROUND

LDS antennas may include an antenna element disposed on a carrier. For instance, a laser device can be used to etch a channel into an exterior surface of the carrier. The shape of the channel can correspond to the shape of an antenna element intended to be disposed on the carrier. The carrier can then be plated in a metal bath such that the channel is filled with a metal needed to form the LDS antenna. LDS antennas can be used in a variety of applications. For instance, LDS antennas may be used in electronic devices such as mobile computing devices (e.g., laptops, cellular phones).

### SUMMARY

Aspects and advantages of embodiments of the present disclosure will be set forth in part in the following description, or can be learned from the description, or can be learned through practice of the embodiments.

One example aspect of the present disclosure is directed to a laser direct structuring (LDS) antenna. The LDS antenna includes a carrier having a dielectric constant. The LDS antenna further includes an LDS-defined antenna element on the carrier. The carrier includes a dielectric tuning resin in at least a portion of the carrier.

Another example aspect of the present disclosure is directed to a laser direct structuring (LDS) antenna. The LDS antenna includes a carrier comprising a first portion having a laser direct structuring (LDS) resin and a second portion having a dielectric tuning resin. The LDS antenna further includes an LDS-defined antenna element on the carrier. The first portion of the carrier has a different dielectric constant relative to the second portion of the carrier.

Another example aspect of the present disclosure is directed to a method of manufacturing a laser direct structuring (LDS) antenna. The method includes forming an LDS-defined antenna element on a carrier having a dielectric constant. The method further includes adjusting the dielectric constant of the carrier based at least in part on one or more characteristics of the LDS-defined antenna element.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 provides a perspective view of an example LDS antenna according to example embodiments of the present disclosure;

FIG. 2 provides a cross-sectional view of the example LDS antenna of FIG. 1;

FIG. 3A-3E provide additional cross-sectional views of example LDS antennas according to example embodiments of the present disclosure;

FIG. 4 provides an example method for manufacturing a laser direct structuring (LDS) antenna according to example embodiments of the present disclosure; and

FIG. 5 provides an example electronic device according to example embodiments of the present disclosure.

Repeat use of reference characters in the present specification and drawings is intended to represent same or analogous features or elements of the invention.

### DETAILED DESCRIPTION

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations. As used herein, the use of the term “about” in conjunction with a numerical value refers to a value that falls within 15% of the stated numerical value.

Example aspects of the present disclosure relate generally to laser direct structuring (LDS) antennas. In general, LDS antennas may include an antenna element on (e.g., disposed on) a carrier having a dielectric constant. The dielectric constant of the carrier may affect one or more operating characteristics of the LDS antenna. For example, an electromagnetic wave propagating through the carrier may be affected by the dielectric constant of the carrier.

Some antenna designs may include a carrier with a fixed dielectric constant. In such antenna designs, antenna operating characteristics such as the resonance frequency may be tuned by adjusting the antenna element. For instance, the metal pattern of an antenna element may be modified (e.g., cut) based on the fixed dielectric constant of the carrier in order tune the resonance of the antenna. This may be difficult for LDS antennas as modifying an LDS-defined antenna element may be expensive and time consuming.

Accordingly, example aspects of the present disclosure are directed to dielectric tuning a carrier of an LDS antenna. The dielectric constant of a carrier may be adjusted (e.g., tuned) based at least in part on one or more characteristics of an LDS-defined antenna element. In some examples, a dielectric tuning resin may be injected into the carrier of the LDS antenna to tune the dielectric constant of the carrier.

One example aspect of the present disclosure is directed to an antenna (e.g., LDS antenna) having an LDS-defined antenna on a carrier. Specifically, the carrier may include a first portion injected with an LDS resin. An LDS-defined antenna element may be at least partially on (e.g., disposed on, positioned on) the first portion of the carrier having the LDS resin.

As used herein, an LDS resin (e.g., LDS suitable resin) may be defined as a resin used for injection molding that is suitable for laser direct structuring. For instance, an antenna element such as an LDS-defined antenna element may be implemented directly onto a portion of a carrier having (e.g., injected with) an LDS resin. Accordingly, an LDS-defined antenna element may be implemented directly onto the first portion having the LDS resin through laser direct structuring (LDS) manufacturing process.

The carrier may further include a second portion injected with a dielectric tuning resin. As used herein, a dielectric tuning resin may be defined as a resin that is used to adjust the dielectric constant of at least a portion of the carrier. Specifically, the dielectric tuning resin may be a resin used for injection molding that has a dielectric constant (k) that is different than the dielectric constant of the LDS resin used in at least one portion of the carrier. Operating characteristics of the antenna such as the resonance may be tuned by injecting the dielectric tuning resin in the carrier.

In some embodiments, the dielectric constant of the dielectric tuning resin may be greater than the dielectric constant of the LDS resin. For example, the dielectric tuning resin may have a dielectric constant (k) that is at least twice that of the dielectric constant (k) of the LDS resin of the carrier.

In some embodiments, the dielectric tuning resin may be a non-LDS resin. As used herein, a non-LDS resin may be defined as a resin used for injection molding that is not suitable for laser direct structuring. For instance, a non-LDS resin may not directly contact the LDS-defined antenna element as the non-LDS resin may not be suitable for channel etching. In such embodiments, the non-LDS dielectric tuning resin may be spaced apart from the LDS-defined antenna element by, for example, a portion of the carrier injected with LDS resin. For instance, the LDS-defined antenna element may be implemented directly onto a first portion having the LDS resin. The non-LDS dielectric tuning resin may be injected into a recess or cavity defined in the first portion that is spaced apart from the LDS-defined antenna element.

Example aspects of the present disclosure provide multiple technical effects and benefits. For example, tuning the dielectric constant of the carrier of an LDS antenna provides for tuning the resonance of an antenna without modifying the antenna element.

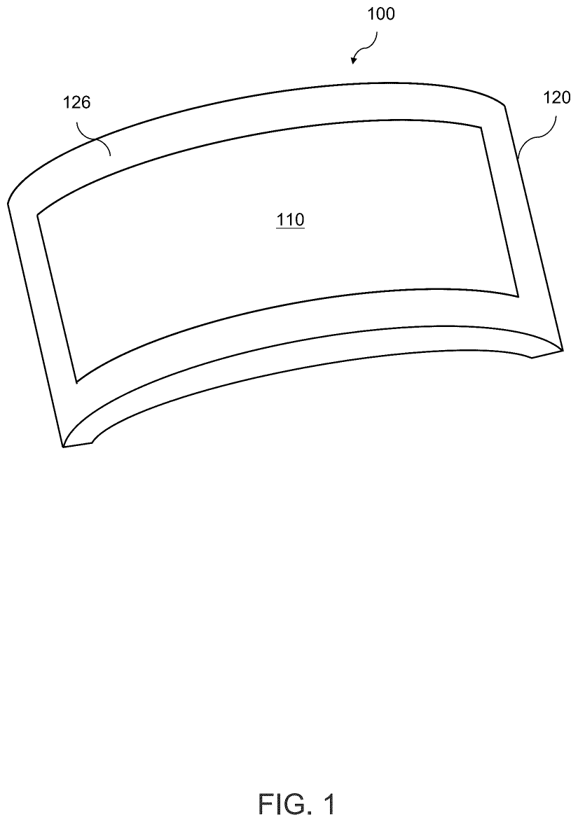

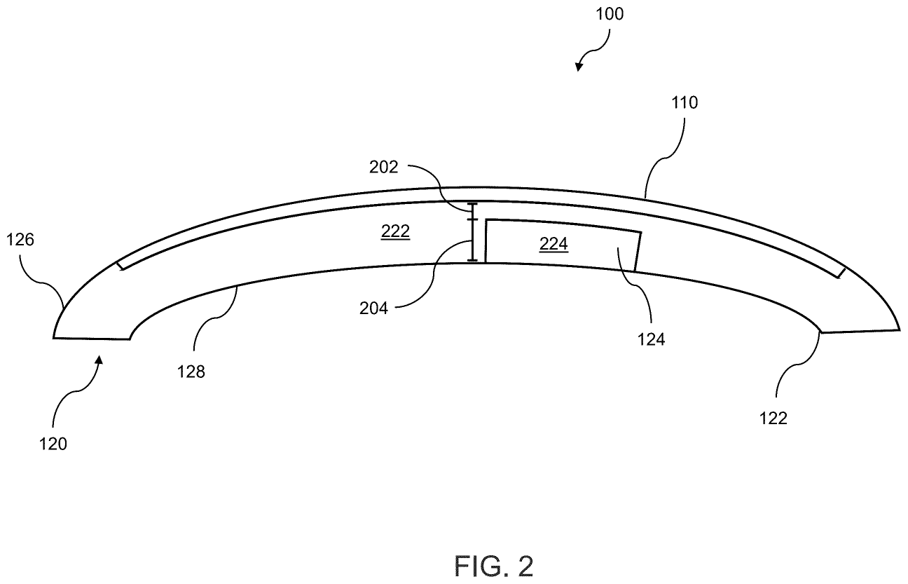

Referring now to the FIGS., FIG. 1-2 illustrate an example laser direct structuring (LDS) antenna according to example embodiments of the present disclosure. Specifically, FIG. 1 provides a perspective view of LDS antenna 100 while FIG. 2 provides a cross-sectional view of LDS antenna 100.

LDS antenna 100 includes an antenna element 110 and a carrier 120 having a dielectric constant. Specifically, carrier 120 may be a plastic carrier formed by injection molding. Antenna element 110 may be an LDS-defined antenna element on (e.g., disposed on, positioned on) carrier 120. Specifically, antenna element 110 may be formed by a laser direct structuring manufacturing process. For example, a laser device may be used to etch one or more channels into an exterior surface of carrier 120. Antenna element 110 may be formed in these channels by, for example, placing carrier 120 in a metal bath such that the channels are filled with metal.

Antenna element 110 may extend along one or more surfaces of carrier 120. As shown in FIG. 1-2, carrier 120 may have a curved configuration with antenna element 110 positioned on curved surface 126 of carrier 120. Accordingly, antenna element 110 may extend along curved surface 126 (e.g., convex curved surface 126) of carrier 120. While antenna element 110 is depicted as rectangular, those of ordinary skill in the art will understand that antenna element 110 may have any suitable shape or pattern without deviating from the scope of the present disclosure. In addition, LDS antenna 100 is depicted in FIG. 1-2 to include a singular LDS-defined antenna element 110, although those of ordinary skill in the art will understand that LDS antenna 100 may include any number of LDS-defined antenna elements 110 on carrier 120 without deviating from the scope of the present disclosure.

Referring now specifically to FIG. 2, a cross-sectional view of example LDS antenna 100 is provided. As shown in FIG. 2, carrier 120 may include a first portion 122. First portion 122 may include an LDS resin 222. For example, first portion 122 of carrier 120 may be injected with LDS resin 222. Specifically, LDS resin 222 may be defined as a resin used for injection molding that is suitable for laser direct structuring and LDS resin 222 may include any compound suitable for laser direct structuring. For example, LDS resin 222 of first portion 122 may be etched such that channels may be formed on a surface 126 of the carrier and antenna element 110 may be formed in the channels. Accordingly, LDS-defined antenna element 110 may be implemented directly onto first portion 122 (e.g., along surface 126) through a laser direct structuring (LDS) manufacturing process.

LDS antenna 100 may further include a second portion 124 having dielectric tuning resin 224. For example, second portion 124 of carrier 120 may be injected with dielectric tuning resin 224. Dielectric tuning resin 224 may be used to adjust the dielectric constant of the carrier 120 (e.g., second portion 124 of carrier 120). Specifically, dielectric tuning resin 224 may be a resin used for injection molding that has a dielectric constant (k) that is different than the dielectric constant of the LDS resin 222 used in the first portion 122.

In some embodiments, the dielectric constant of the dielectric tuning resin 224 is greater than the dielectric tuning resin of the LDS resin 222. In some embodiments, dielectric tuning resin 224 may have a dielectric constant (k) that is at least twice that of the dielectric constant (k) of the LDS resin of the carrier. For instance, the LDS resin 222 may have a dielectric constant of about 3, and the dielectric tuning resin 224 may have a dielectric constant that is, for instance, greater than about 8.

As shown in FIG. 2, second portion 124 may be recessed in first portion 122. Accordingly, second portion 124 may be spaced apart from the LDS-defined antenna element 110 by a first distance 202. Specifically, the second portion 124 may be spaced apart from the antenna element 110 by first portion 122 such that first distance 202 extends through the LDS resin 222 of the first portion 122. The second portion 124 having the dielectric tuning resin 224 may span a second distance 204. In some embodiments, a width of carrier 120 may be defined as the distance from antenna element 110 (e.g., on curved surface 126) to a bottom surface 128 of the carrier 120. As shown in FIG. 2, the width of carrier 120 may equate to the summation of distance 202 and distance 204 such that an electromagnetic signal associated with antenna element 110 may propagate through carrier 120 by traveling through the LDS resin 222 for the first distance 202 and the dielectric tuning resin for the second distance 204.

In some embodiments, distance 204 may be greater than distance 202, such that an electromagnetic signal associated with antenna element 110 travelling through the carrier will travel a greater distance through the dielectric tuning resin 224 than the LDS resin 222. In further embodiments, distance 204 may be at least 3 times the length of distance 202 such that an electromagnetic signal associated with LDS-defined antenna element 110 will travel a distance 204 through the dielectric tuning resin 224 that is at least 3 times greater than the distance 202 that the signal travels through the LDS resin 222. For instance, distance 202 may be about 0.6 millimeters while distance 204 may be about 2 mm. Accordingly, an electromagnetic signal associated with LDS-defined antenna element 110 may propagate through 0.6 mm of the LDS resin 222 and 2 mm of dielectric tuning resin 224. In some embodiments, dielectric tuning resin 224 may be a non-LDS resin. For example, the dielectric tuning resin 224 may not be suitable for laser direct structuring such that LDS-defined antenna element 110 may not be formed on a portion of the carrier 120 (e.g., second portion 124) containing dielectric tuning resin 224. In alternatively embodiments, dielectric tuning resin 224 may be an LDS resin (e.g., LDS suitable resin) that is suitable for laser direct structuring.

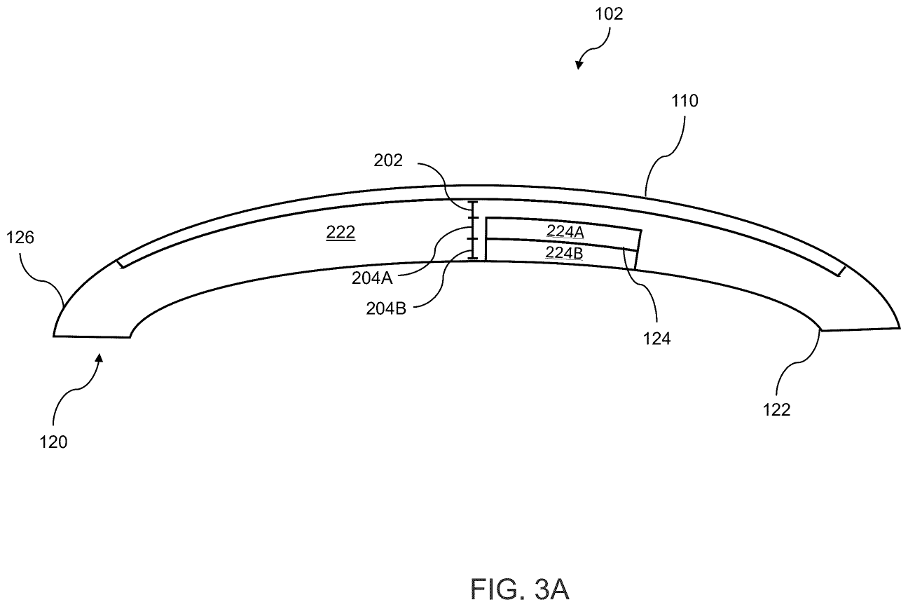

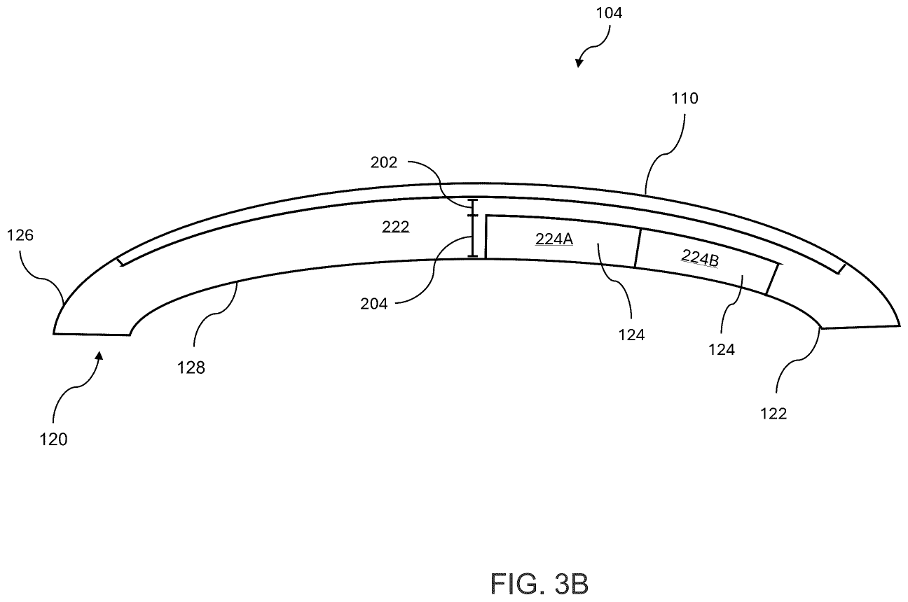

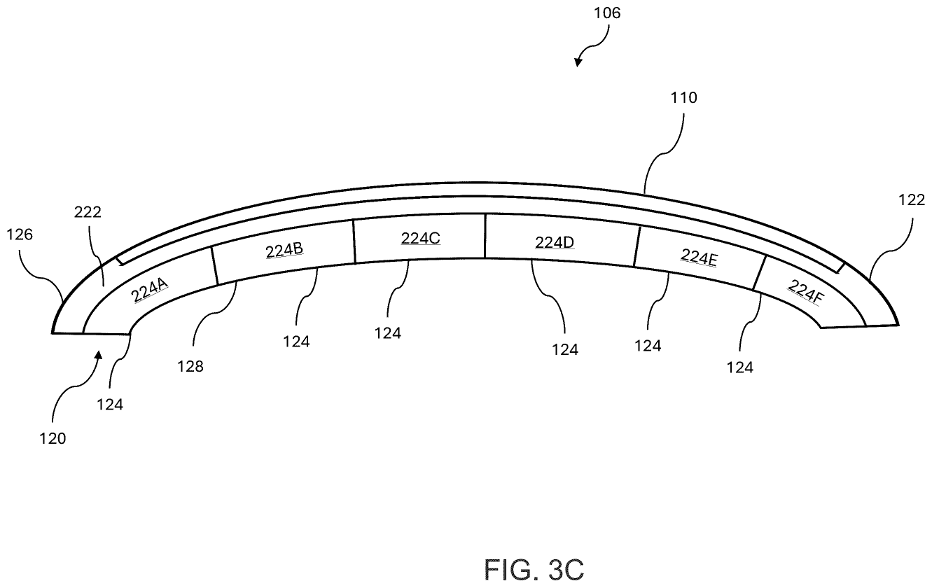

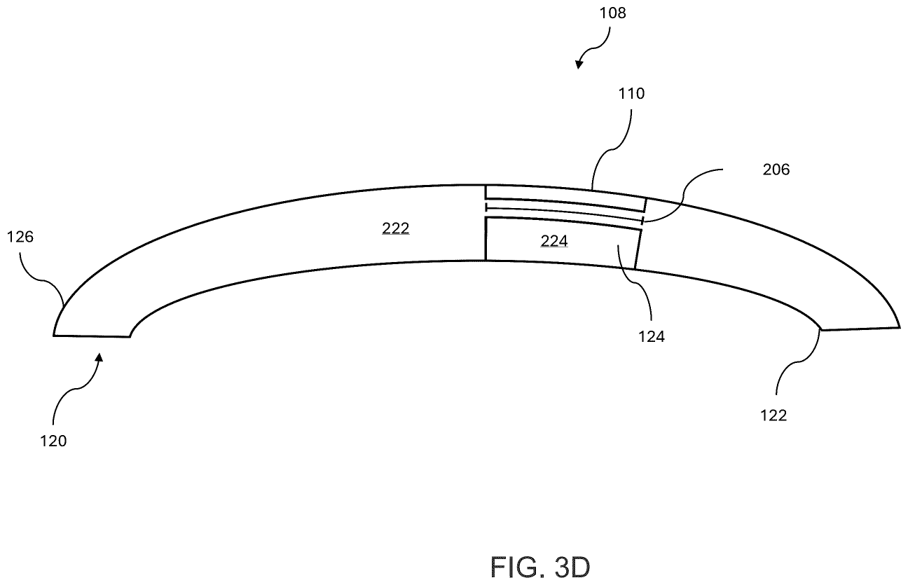

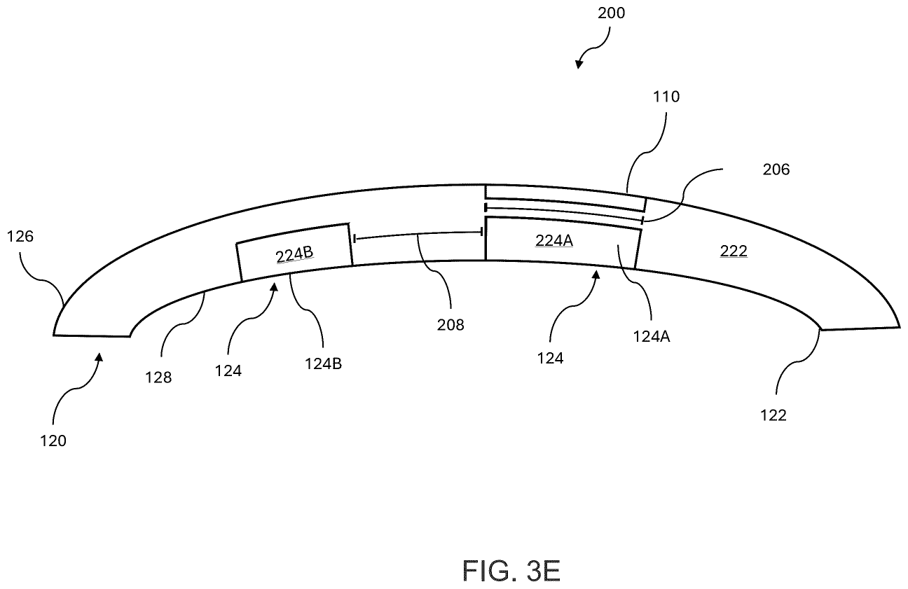

Referring now to FIG. 3A, a cross-sectional view of another LDS antenna according to example embodiments of the present disclosure is provided. FIG. 3A depicts an LDS antenna 102 having an LDS-defined antenna element 110 on a first surface 126 of carrier 120. The LDS-defined antenna element 110 may contact first portion 122 of carrier 120. The first portion may have LDS resin 222. Carrier 120 further incudes second portion 124. As shown in FIG. 3A, second portion 124 may be recessed in first portion 122 and may include multiple dielectric tuning resins 224A, 224B. For instance, dielectric tuning resins may 224A, 224B may be layered within the second portion 124.

In such embodiments, an electromagnetic signal associated with antenna element 110 travelling through carrier 120 may travel a first distance 202 through the LDS resin 222, a second distance 204A through dielectric tuning resin 224A, and a third distance 204B through dielectric tuning resin 224B. In some embodiments, distance 204A may be the same as distance 204B. In alternative embodiments, distance 204A may be different than distance 204B.

Dielectric tuning resin 224A may have a dielectric constant (k) that is different than the dielectric constant of dielectric tuning resin 224B. Additionally, both dielectric tuning resins 224A, 224B may have dielectric constants that are different than the dielectric constant of LDS resin 222. In some embodiments, dielectric tuning resins 224A, 224B may be non-LDS resins.

For example, dielectric tuning resins 224A, 224B may not be suitable for laser direct structuring such that LDS-defined antenna element 110 may not be formed on a portion of the carrier 120 (e.g., second portion 124) containing dielectric tuning resin 224. In alternatively embodiments, dielectric tuning resins 224A, 224B may be LDS resins (e.g., LDS suitable resins) that are suitable for laser direct structuring.

FIG. 3B provides a cross-sectional view of yet another LDS antenna according to example embodiments of the present disclosure. FIG. 3B depicts an LDS antenna 104 having an LDS-defined antenna element 110 on a first surface 126 of a carrier 120. The LDS-defined antenna element 110 may contact first portion 122 of carrier 120. The first portion may have LDS resin 222. As shown in FIG. 3B, carrier 120 may include a plurality of second portions 124. Each second portion 124 may be recessed in first portion 122, extending from a bottom surface 128 of carrier 120.

Each second portion 124 may include a dielectric tuning resin 224A, 224B. Dielectric tuning resin 224A may be different than dielectric tuning resin 224B. For instance, dielectric tuning resin 224A may have a different dielectric constant than dielectric tuning resin 224B. Additionally, both dielectric tuning resins 224A, 224B may have dielectric constants that are different than the dielectric constant of LDS resin 222. Accordingly, each second portion 124 may have a dielectric constant that is different than other portions of carrier 120.

In some embodiments, such as that shown in FIG. 3B, dielectric tuning resin 224A may not overlap dielectric tuning resin 224B. For example, a portion of antenna element 110 may correspond to dielectric tuning resin 224A while a different portion of antenna element 110 may correspond to dielectric tuning resin 224B. Each second portion 124 may extend from a bottom surface 128 of carrier 120 for a distance 204, such that each second portion 124 is spaced apart from the LDS-defined antenna element 110 by distance 202.

FIG. 3C provides a cross-sectional view of yet another LDS antenna according to example embodiments of the present disclosure. FIG. 3C depicts an LDS antenna 106 having an LDS-defined antenna element 110 on a first surface 126 of a carrier 120. The LDS-defined antenna element 110 may contact first portion 122 of carrier 120. The first portion may have LDS resin 222. As shown in FIG. 3C, carrier 120 may include a plurality of second portions 124 spanning the length of carrier 120. As such, the entire bottom surface 128 of carrier 120 may be defined by the plurality of second portions 124.

Each second portion 124 may include a dielectric tuning resin 224A, 224B, 224C, 224D, 224E, 224F. In some embodiments, each second portion may have a different dielectric tuning resin 224A, 224B, 224C, 224D, 224E, 224F having a different dielectric constant. For example, each portion of the carrier 120 may have a different dielectric constant relative to the other portions of the carrier. As shown in FIG. 3C, antenna element 110 may completely overlap some second portions 124, while antenna element 110 only partially overlaps other second portions 124.

FIG. 3D provides a cross-sectional view of yet another LDS antenna according to example embodiments of the present disclosure. FIG. 3D depicts an LDS antenna 108 having an LDS-defined antenna element 110 on a first surface 126 of a carrier 120. The LDS-defined antenna element 110 may contact first portion 122 of carrier 120. The first portion may have LDS resin 222.

As shown in FIG. 3D, second portion 124 having dielectric tuning resin 224 may correspond to LDS-defined antenna element 110. For instance, second portion 124 may have a length 206 that corresponds to the length of antenna element 110. Additionally, an area of antenna element 110 defined on surface 126 may correspond to an area of second portion 124.

For instance, second portion 124 may have an area corresponding to the area of antenna element 110 on surface 126 of carrier 120.

Referring now to FIG. 3E, a cross-sectional view of yet another LDS antenna according to example embodiments of the present disclosure is provided. FIG. 3E depicts an LDS antenna 200 having an LDS-defined antenna element 110 on a first surface 126 of a carrier 120. The LDS-defined antenna element 110 may contact first portion 122 of carrier 120. The first portion 122 may have LDS resin 222. Carrier 120 may include a plurality of second portions 124 (e.g., second portion 124A and second portion 124B) having dielectric tuning resins 224A, 224B. Each second portion 124A, 124B may be recessed in first portion 122 and extend from bottom surface 128 of carrier 120.

As shown in FIG. 3E, second portion 124A having dielectric tuning resin 224A may correspond to LDS-defined antenna element 110, overlapping the antenna element 110 along a length 206. Another second portion 124B having dielectric tuning resin 224B may not overlap with antenna element 110. For instance, second portion 124A may have an area corresponding to the area of antenna element 110 on surface 126 of carrier 120. Second portion 124B may have an area that does not overlap with antenna element 110 on surface 126 of carrier 120. In some embodiments, second portion 124A may be spaced apart from second portion 124B by a distance 208.

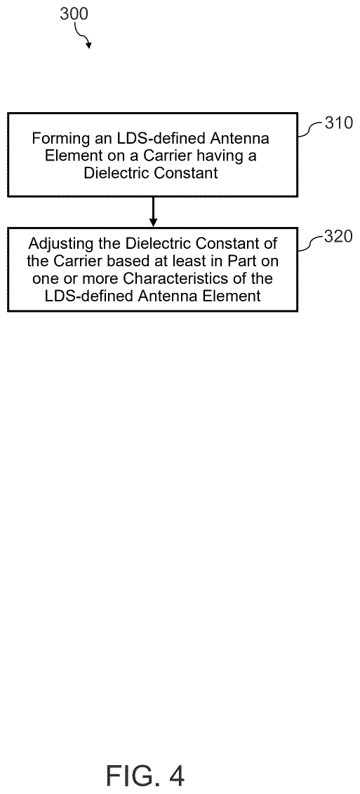

Referring now to FIG. 4, an example method for manufacturing a laser direct structuring (LDS) antenna according to example embodiments of the present disclosure is provided. While method 300 is generally discussed with reference to LDS antenna 100 as depicted in FIG. 1-2, those of ordinary skill in the art will understand that method 300 may be implemented in the manufacturing of any suitable antenna, such as any of the LDS antennas described herein. Method 300 provides a series of steps performed in a particular order for purposes of illustration and discussion. Those of ordinary skill in the art, using the disclosures provided herein, will understand that any step of method 300 discussed herein can be adapted, rearranged, expanded, omitted, or modified in various ways without deviating from the scope of the present disclosure.

At (310), method 300 includes forming an LDS-defined antenna element on a carrier having a dielectric constant. LDS-defined antenna element 110 of LDS antenna 100 may be formed on carrier 120 with laser direct structuring. For instance, as best shown in FIG. 2, a channel may be etched into the LDS resin 222 of carrier 120 (e.g., first portion 122 of carrier 120). The carrier 120 may then be plated in, for example, a metal bath such that the channel is filled, forming the LDS-defined antenna element 110. Carrier 120 may have a dielectric constant. For example, LDS resin 222 may be used to form a first portion 122 of the carrier 120. As such, the dielectric constant of the carrier 120 may be defined by the dielectric constant (k) of the LDS resin 222.

At (320), method 300 includes adjusting the dielectric constant of the carrier based at least in part on one or more characteristics of the LDS-defined antenna element. For instance, dielectric tuning resin 224 may be injected into a second portion 124 of carrier 120. Dielectric tuning resin 224 may have a dielectric constant that is different than that of the carrier 120 (e.g., LDS resin 222). An electromagnetic signal associated with LDS-defined antenna element 110 may propagate through carrier 120 by traveling through the LDS resin 222 for the first distance 202 and the second portion 124 for the second distance 204. Accordingly, the dielectric constant of the carrier may be adjusted by injecting the dielectric tuning resin 224 into carrier 120.

In addition, the dielectric constant of carrier 120 may be adjusted based at least in part on one or more characteristics of the LDS-defined antenna element 110. In some embodiments, the one or more characteristics may include the resonance of the antenna element 110. For example, adjusting (e.g., increasing) the dielectric constant of the carrier 120 may tune (e.g., shift lower) the resonant frequency of antenna element 110. In some embodiments, the dielectric constant of the dielectric tuning resin 224 may be determined based on the one or more characteristics of the antenna element 110. For example, a dielectric tuning resin with a dielectric constant of 8 may be used for an antenna element having a first resonant frequency, while a dielectric tuning resin with a dielectric constant of 13 may be used for an antenna element having a second resonant frequency.

In some embodiments, a first portion 122 of the carrier 120 may include the LDS resin 222. The dielectric tuning resin 224 may be injected into a cavity or recess defined in the first portion 122. Accordingly, the dielectric tuning resin 224 may be spaced apart from the LDS-defined antenna element 110. In addition, the LDS-defined antenna element 110 may be positioned on a curved surface 126 of the carrier 120.

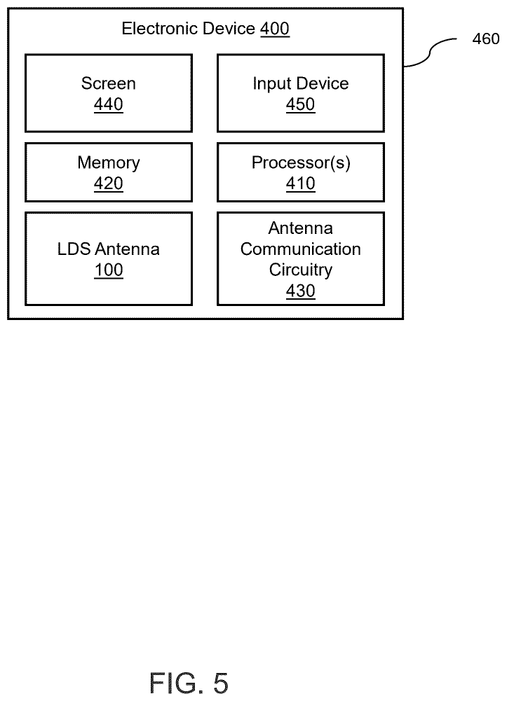

FIG. 5 provides a block diagram depicting an example electronic device according to example embodiments of the present disclosure. Electronic device 400 may be any suitable electronic device configured to have wireless communication with one or more remote devices. For instance, electronic device 400 can be a computing device (e.g., laptop, desktop, display with one or more processors), mobile device (e.g., phone, tablet, wearable device (e.g., watch)), vehicle, nautical vehicle, aircraft, satellite, keyless entry device, or other electronic device. While electronic device 400 is described in FIG. 5 with reference to LDS antenna 100 as shown in FIG. 1-2, those of ordinary skill in the art, using the disclosures provided herein, will understand that any of the LDS antennas described herein can be implemented in electronic device 400 for use in a variety of applications without deviating from the scope of the present disclosure. As shown in FIG. 5, electronic device 400 includes an LDS antenna, such as LDS antenna 100 as provided herein. Electronic device 400 may further include memory 420 and one or more processor(s) 410. Processor(s) 410 can include any suitable processing device and may be configured to perform a variety of computer implemented functions. As used herein, the term “processor” refers not only to integrated circuits referred to in the art as being included in a computer, but may also refer to a microprocessor, CPU, GPU, controller, microcontroller, a microcomputer, a programmable logic controller (PLC), an application specific integrated circuit (ASIC), a Field Programmable Gate Array (FPGA), and/or other programmable circuits. As shown, electronic device 400 may further include memory 420. Examples of memory 420 can include computer-readable media including, but not limited to, non-transitory computer-readable media, such as RAM, ROM, hard drives, flash drives, or other suitable memory devices. Memory 420 can store information accessible by the one or more processor(s) 410, including computer-readable instructions that can be executed by the one or more processor(s) 410. For example, the computer-readable instructions can be software written in any suitable programming language or may be implemented in hardware. In some embodiments, the one or more processor(s) 410 along with memory 420 may be defined as one or more control devices configured to control operation of LDS antenna 100.

Electronic device 400 may further include communication circuitry 430. Communication circuitry 430 may include electrical components (e.g., radio frequency (RF) circuitry, transmission line, transceiver, receiver, transmitter, matching circuit etc.) configured to facilitate communication of information over the antenna. In some embodiments, processor(s) 410 may be in electrical communication with LDS antenna 100 via communication circuitry 430. In this manner, RF signals received at LDS antenna 100 may be provided to processor(s) 410 via communication circuitry 430. In addition, the one or more processor(s) 410 may be configured to provide data to be modulated onto a transmit RF signal provided to the LDS antenna 100 via communication circuitry 430 (e.g., RF circuitry of communication circuitry 430). For instance, communication circuitry 430 may include an RF feed line and/or matching circuitry. RF signals and/or a control signal may be communicated over a transmission line (e.g., coaxial cable) of communication circuitry 430.

Electronic device 400 may further include a housing 460 configured to house components of electronic device 400. In some embodiments, electronic device 400 may further include one or more screen(s) 440 (e.g., display screen, touch screen). In some embodiments, electronic device 400 may further include an input device 450 (e.g., key pad, touch pad, keyboard).

One example aspect of the present disclosure is directed to a laser direct structuring (LDS) antenna. The LDS antenna includes a carrier having a dielectric constant. The LDS antenna further includes an LDS-defined antenna element on the carrier. The carrier includes a dielectric tuning resin in at least a portion of the carrier.

In some examples, the dielectric tuning resin is spaced apart from the LDS-defined antenna element by a distance.

In some examples, the distance is about 0.6 millimeters (mm).

In some examples, the LDS-defined antenna element is positioned on a curved surface of the carrier.

In some examples, the carrier includes a first portion having an LDS resin and a second portion having the dielectric tuning resin. The dielectric constant of the LDS resin is different than the dielectric constant of the dielectric tuning resin.

In some examples, the second portion is recessed in the first portion, the LDS-defined antenna element positioned on the first portion of the carrier.

In some examples, the dielectric constant of the dielectric tuning resin is greater than the dielectric constant of the LDS resin.

In some examples, the dielectric constant of the dielectric tuning resin is at least twice that of the dielectric constant of the LDS resin.

In some examples, the dielectric tuning resin is a non-LDS resin.

Another example aspect of the present disclosure is directed to a laser direct structuring (LDS) antenna. The LDS antenna includes a carrier comprising a first portion having a laser direct structuring (LDS) resin and a second portion having a dielectric tuning resin. The LDS antenna further includes an LDS-defined antenna element on the carrier. The first portion of the carrier has a different dielectric constant relative to the second portion of the carrier.

In some examples, the dielectric constant of the second portion is greater than the dielectric constant of the first portion.

In some examples, the second portion is spaced apart from the LDS-defined antenna element by a distance.

In some examples, the distance is about 0.6 millimeters (mm).

In some examples, the dielectric tuning resin is a non-LDS resin.

In some examples, the LDS-defined antenna element is positioned on a curved surface of the first portion of the carrier.

Another example aspect of the present disclosure is directed to a method of manufacturing a laser direct structuring (LDS) antenna. The method includes forming an LDS-defined antenna element on a carrier having a dielectric constant. The method further includes adjusting the dielectric constant of the carrier based at least in part on one or more characteristics of the LDS-defined antenna element.

In some examples, adjusting the dielectric constant of the carrier comprises injecting a dielectric tuning resin into the carrier.

In some examples, the dielectric tuning resin is a non-LDS resin.

In some examples, the dielectric tuning resin is spaced apart from the LDS-defined antenna element.

In some examples, the LDS-defined antenna element is positioned on a curved surface of the carrier.

While the present subject matter has been described in detail with respect to specific example embodiments thereof, it will be appreciated that those skilled in the art, upon attaining an understanding of the foregoing can readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A laser direct structuring (LDS) antenna, comprising:
a carrier having a dielectric constant; and
an LDS-defined antenna element on the carrier,
wherein the carrier comprises a dielectric tuning resin in at least a portion of the carrier.

2. The LDS antenna of claim 1, wherein the dielectric tuning resin is spaced apart from the LDS-defined antenna element by a distance.

3. The LDS antenna of claim 2, wherein the distance is about 0.6 millimeters (mm).

4. The LDS antenna of claim 1, wherein the LDS-defined antenna element is positioned on a curved surface of the carrier.

5. The LDS antenna of claim 1, wherein the carrier comprises:
a first portion having an LDS resin; and
a second portion having the dielectric tuning resin,
wherein the dielectric constant of the LDS resin is different than the dielectric constant of the dielectric tuning resin.

6. The LDS antenna of claim 5, wherein the second portion is recessed in the first portion, the LDS-defined antenna element positioned on the first portion of the carrier.

7. The LDS antenna of claim 5, wherein the dielectric constant of the dielectric tuning resin is greater than the dielectric constant of the LDS resin.

8. The LDS antenna of claim 7, wherein the dielectric constant of the dielectric tuning resin is at least twice that of the dielectric constant of the LDS resin.

9. The LDS antenna of claim 5, wherein the dielectric tuning resin is a non-LDS resin.

10. A laser direct structuring (LDS) antenna, comprising:
a carrier comprising a first portion having a laser direct structuring (LDS) resin and a second portion having a dielectric tuning resin; and
an LDS-defined antenna element on the carrier,
wherein the first portion of the carrier has a different dielectric constant relative to the second portion of the carrier.

11. The LDS antenna of claim 10, wherein the dielectric constant of the second portion is greater than the dielectric constant of the first portion.

12. The LDS antenna of claim 10, wherein the second portion is spaced apart from the LDS-defined antenna element by a distance.

13. The LDS antenna of claim 12, wherein the distance is about 0.6 millimeters (mm).

14. The LDS antenna of claim 10, wherein the dielectric tuning resin is a non-LDS resin.

15. The LDS antenna of claim 10, wherein the LDS-defined antenna element is positioned on a curved surface of the first portion of the carrier.

16. A method of manufacturing a laser direct structuring (LDS) antenna, the method comprising:
forming an LDS-defined antenna element on a carrier having a dielectric constant; and
adjusting the dielectric constant of the carrier based at least in part on one or more characteristics of the LDS-defined antenna element.

17. The method of claim 16, wherein adjusting the dielectric constant of the carrier comprises injecting a dielectric tuning resin into the carrier.

18. The method of claim 17, wherein the dielectric tuning resin is a non-LDS resin.

19. The method of claim 17, wherein the dielectric tuning resin is spaced apart from the LDS-defined antenna element.

20. The method of claim 16, wherein the LDS-defined antenna element is positioned on a curved surface of the carrier.
